(19) United States
(12) Patent Application Publication
(10) Pub. No.: US 2024/0411014 A1
(43) Pub. Date: Dec. 12, 2024

(54) Measurement Cart with Sensor

(71) Applicant: Dynamic Research, Inc., Torrance, CA (US)

(72) Inventors: Jordan Y Silberling, Redondo Beach, CA (US); Ronald Wagner, Manhattan Beach, CA (US); Nenad Bozin, San Pedro, CA (US)

(21) Appl. No.: 18/695,495

(22) PCT Filed: Oct. 18, 2022
(86) PCT No.: PCT/US2022/047060

§ 371 Date: Mar. 26, 2024

Related U.S. Application Data
(60) Provisional application No. 63/257,994, filed on Oct. 20, 2021.

(51) Int. Cl. G01S 13/931; G01S 7/40; G01S 7/52

(52) U.S. Cl. CPC G01S 13/931; G01S 7/4021; G01S 7/52004

(57) ABSTRACT

A system and method are provided for measuring a characteristic signature of an object. The system includes a computer in data communication with a cart processor, the computer constructed to calculate a path. The system also has a measurement cart with a mobile platform comprising a steering actuator connected to a steered wheel and a motor connected to a driven wheel, a characteristics sensor directed at the object, a GPS module, and the cart processor is constructed to control the motor and steering actuator, and constructed to receive data from the characteristics sensor, and GPS module. The cart processor performs the steps of: (a) actuating the steering actuator based on location data generated from the GPS module and the calculated path; (b) actuating the motor based on location data generated from the GPS module and the calculated path; and (c) recording data generated from the characteristics sensor.

### 1.0 RELATED APPLICATIONS

The present invention claims priority as the non-provisional of U.S. Provisional Patent Application No. 63/325,794 entitled “Radar Measurement Cart” filed Oct. 20, 2021 which is hereby incorporated in its entirety including all tables, figures and claims.

### 2.0 TECHNICAL FIELD

The present invention relates to devices, systems, and methods for testing crash avoidance technologies.

### 3.0 BACKGROUND

The system disclosed herein can be used with, but is not limited to, vehicles employed in crash avoidance technologies disclosed in the following patents and patent applications developed by the same inventors and assigned to the same assignee: U.S. Pat. No. 8,428,863 issued on Apr. 23, 2013 titled “Devices, System, and Methods for Testing Crash Avoidance Technologies”; U.S. Pat. No. 8,428,864 issued on Apr. 23, 2013 titled “Devices, System, and Methods for Testing Crash Avoidance Technologies”; U.S. Pat. No. 8,447,509 issued on May 21, 2013 titled “System and Method for Testing Crash Avoidance Technologies”; U.S. Pat. No. 8,457,877 issued on Jun. 4, 2013 titled “Devices, System, and Methods for Testing Crash Avoidance Technologies”; U.S. Pat. No. 8,583,358 issued on Nov. 12, 2013 titled “Devices, System, and Methods for Testing Crash Avoidance Technologies”; U.S. Pat. No. 8,589,062 issued on Nov. 19, 2013 titled “Devices, System, and Methods for Testing Crash Avoidance Technologies”; U.S. Pat. No. 8,751,143 issued on Jun. 10, 2014 titled “System and Method for Testing Crash Avoidance Technologies”; U.S. Pat. No. 8,755,999 issued on Jun. 17, 2014 titled “System and Method for Testing Crash Avoidance Technologies”; U.S. Pat. No. 8,762,044 issued on Jun. 24, 2014 titled “System and Method for Testing Crash Avoidance Technologies”; U.S. Pat. No. 9,182,942 issued on Nov. 10, 2015 titled “System and Method for Testing Crash Avoidance Technologies”; U.S. Pat. No. 9,827,998 issued on Nov. 28, 2017 titled “System and Method for Testing Crash Avoidance Technologies”; U.S. Pat. No. 10,585,429 issued on Mar. 10, 2020 titled “Robotic Steering Controller for Optimal Free Response Evaluation”; U.S. Pat. No. 10,697,856 issued Jun. 30, 2020 titled “A Soft Collision Partner (AKA Soft Car) Used in System For Testing Crash Avoidance Technologies”;

PCT Application No. PCT/US22/45956 filed on Oct. 6, 2022 titled “Articulating Pedestrian Dummy for Vehicle Testing”; PCT Application No. PCT/US22/46246 filed on Oct. 11, 2022 titled “Wirelessly Controlled Lights for Surrogate Targets”; U.S. Provisional Application 63/281,548 filed on Nov. 19, 2021 title “System and Method for Testing Crash Avoidance Technologies”; and U.S. Provisional Application 63/349,680 filed on Jun. 7, 2022 title “System and Method for Testing Crash Avoidance Technologies”. Each of these patents and patent applications is incorporated herein in their entirety including all tables, figures, and claims.

As Advanced Crash Avoidance Technologies (ACATs) such as Forward Collision Warning (FCW), Crash Imminent Braking Systems and other advanced technologies continue to be developed, the need for full-scale test methodologies that can minimize hazards to test personnel and damage to equipment has rapidly increased. Evaluating such ACAT systems presents many challenges. For example, the evaluation system should be able to deliver a potential Soft Collision Partner (Soft CP), also known as a surrogate target, reliably and precisely along a trajectory that would ultimately result in a crash in a variety of configurations, such as rear-ends, head-ons, crossing paths, and sideswipes. Additionally, the Soft CP should not pose a substantial physical risk to the test driver, other test personnel, equipment, or to subject vehicles in the event that the collision is not avoided. This challenge has been difficult to address. Third, the Soft CP should appear to the subject vehicle as the actual item being simulated, such as a motor vehicle, a pedestrian, or other object. For example, the Soft CP should provide a consistent signature for radar and other characteristics sensors to the various subject vehicles, substantially identical to that of the item being simulated.

As disclosed in the inventors' previous patent applications, fully incorporated herein by reference, the Guided Soft Target (GST) system includes a dynamic motion element (DME) as a mobile and controllable platform that carries the Soft CP. The DME is of such shape and dimension that it can be run over by the vehicle under test (aka the subject vehicle), with little to no damage to either the DME or the subject vehicle. When a collision occurs with the GST system, the subject vehicle impacts the Soft CP, which then absorbs the collision and may collapse and/or separate from the DME. Such a Soft CP is disclosed in U.S. Pat. No. 8,428,863, incorporated by reference. This is disclosed fully in the previous patent applications listed above and incorporated by reference.

As vehicle-based sensors and detection algorithms become more sophisticated, it is imperative to have accurate and repeatable characteristic signatures; otherwise robust testing of the cars ACAT system will suffer.

Therefore, a system to accurately and consistently measure the characteristic signatures of a Soft CP or other object that a vehicle may encounter would be advantageous. The system should yield data that realistically emulates vehicles or other objects, and that data may be used to improve ACAT testing.

### 4.0 SUMMARY

The present invention provides an elegant solution to the needs described above and offers numerous additional benefits and advantages, as will be apparent to persons of skill in the art. Disclosed herein is a measurement cart that takes accurate and repeatable characteristic measurements of objects in the field. It can be used for verification and calibration of surrogate targets and dummies, or for measurements of real objects to better understand their characteristics. The measurement cart may use differential-GPS (2 cm accuracy) and automatic steering and propulsion to control and record the position and orientation of the characteristics sensor with respect to the subject vehicle, or object being measured. The measurement cart can be fitted with a variety of characteristics sensors such as radar, LiDAR, ultra-sonic and near/far infrared sensors. It is particularly advantageous to mount multiple characteristics sensors on the cart to obtain data for more than one characteristic.

A system and method are provided for measuring a characteristic signature of an object. The system includes a computer in data communication with a cart processor, the computer constructed to calculate a path. The system also has a measurement cart with a mobile platform comprising a steering actuator connected to a steered wheel and a motor connected to a driven wheel, a characteristics sensor directed at the object, a GPS module (i.e., GPS antenna and a receiver), and the cart processor is constructed to control the motor and steering actuator, and constructed to receive data from the characteristics sensor and GPS module. The cart processor performs the steps of: (a) actuating the steering actuator based on location data generated from the GPS module and the calculated path; (b) actuating the motor based on location data generated from the GPS module and the calculated path; and (c) recording data generated from the characteristics sensor. The computer may be integrated into the cart or remote from the cart.

The computer may access the data from the cart processor, and processes the data to generate a file representing the characteristic signature of the object. The computer may be in wireless data communication with the cart processor. The computer may also transfer the data to an external processor, and the external processor processes the data to generate a file representing the characteristic signature of the object.

A sensor arm bracket may be slidably attached to the support post, and a sensor arm attached to the sensor arm bracket. The characteristics sensor is attached to the sensor arm. The characteristics sensor may have a height adjustment and/or a rotational adjustment. The characteristics sensor may be a plurality of characteristics sensors, and step (c) includes recording the data from the plurality of characteristics sensors simultaneously. The characteristics sensor may be at a fixed angle and/or a fix range relative to the object during at least a portion of the calculated path.

The cart can also include an inertial measurement unit (IMU) connected to the cart processor, and steps (a) and (b) are based on data from the IMU. The cart can also include a battery connected to the cart processor.

A mast may extend from the mobile platform, and a portion of the GPS module may be mounted thereto. A support post may also extend from the mobile platform, and the computer may detachably mounts thereto.

A cart is further disclosed that includes a mobile platform with a steering actuator connected to a steered wheel. The cart also has a characteristics sensor, a GPS module, an inertial measurement unit (IMU), and a cart processor connected to the steering actuator, characteristics sensor, GPS module and IMU. The cart processor may perform the following steps: (a) actuate the steering actuator based on data generated from the GPS module and data generated from the IMU; and (b) record data generated from the characteristics sensor. The cart may also have a motor connected to the cart processor and constructed to drive a driven wheel, with the cart processor also (c) actuates the motor based on location data generated from the GPS module and data generated from the IMU.

A computer may be in data communication with the cart processor and may calculate a path. The cart processor performs steps (a) and (c) based on the calculated path. The characteristics sensor may be at a fixed angle and/or a fix range relative to the object during at least a portion of the calculated path. The characteristics sensor may be height and rotationally adjustable.

A method for measuring a characteristic signature of an object using a measurement cart is also disclosed. The cart may have a mobile platform with automatic steering and a characteristics sensor. The method includes (a) setting the origin of the target; (b) providing a path; (c) pointing the characteristics sensor at the target; (d) propelling the mobile platform, while the mobile platform is steered automatically based on the path; and (e) recording data from characteristics sensor.

The mobile platform may also include automatic propulsion, and step (d) is done automatically. The propulsion of step (d) may be provided by a user. The path may maintain the characteristics sensor at a fixed angle and/or a fixed range relative to the object during at least a portion of step (d). The path can be based on a plurality angles defined by a user, or upon a fixed range defined by a user.

The cart in the method may include a GPS module constructed to locate the position of the cart, and step (a) is based upon the GPS location of the cart. The method can further include processing the characteristics sensor data to generate a file representing the characteristic signature of the object. The file may be a radial graph.

Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### 5.0 BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. Furthermore, various features of different disclosed embodiments can be combined to form additional embodiments, which are part of this disclosure. It will be understood that certain components and details may not appear in the figures to assist in more clearly describing the invention.

FIG. 1 illustrates an automatic measurement cart.

FIG. 2A illustrates the internal components of the mobile platform of the cart.

FIG. 2B illustrates the top surface of the mobile platform of the cart.

FIG. 2C illustrates the various components of the adjustable arm support bracket.

FIG. 2D illustrates the height adjustability of the sensor arm.

FIG. 2E illustrates the rotational adjustability of the sensor arm.

FIG. 2F illustrates the rotational adjustability of the sensor arm.

FIG. 3A is a schematic of the various electrical components of the cart where the cart processor and computer are separated.

FIG. 3B illustrates the computer detached from the cart and communicating with the cart and an external processor.

FIG. 4A is a schematic of the various electrical components of the cart where the cart processor and computer are integrated.

FIG. 4B illustrates the cart communicating with an external processor.

FIG. 5A illustrates the cart used to measure a characteristic signature of an object at a fixed range.

FIG. 5B illustrates an enlarged view of the cart in FIG. 5A, specifically noting that the sensor arm is rotated 90 degrees from the position shown in FIG. 1.

FIG. 6A illustrates the cart used to measure a characteristic signature of an object at a fixed angle.

FIG. 6B illustrates an enlarged view of the cart in FIG. 6A, specifically noting that the sensor arm is in the same position shown in FIG. 1.

FIG. 7A is a screenshot of the cart's operational software dashboard in the Fixed Angle configuration.

FIG. 7B is a screenshot of the cart's operational software dashboard in the Fixed Range configuration.

FIG. 7C is a screenshot of the cart's operational software speed control setup window.

FIG. 7D illustrates the auto drive parameters used in the cart's operational software.

FIG. 7E is a screenshot of the cart's operational software view angle setup window.

FIG. 7F illustrates is a screenshot of the cart's operational software offset origin window.

FIG. 8A illustrates a method implemented automatically by the cart to measure a characteristic signature of an object at a single fixed angle, starting further than the start distance.

FIG. 8B illustrates a method implemented automatically by the cart to measure a characteristic signature of an object at a single fixed angle, starting closer than the start distance.

FIG. 8C illustrates a method implemented automatically by the cart to measure a characteristic signature of an object at multiple fixed angles.

FIG. 9A is a sample signature for the radar characteristic of an object (subject vehicle) at a fixed range.

FIG. 9B is a sample radar signature of an object (subject vehicle) at a fixed angle.

FIG. 10A is a sample radar signature of an object (motorcycle) at a fixed range.

FIG. 10B is a sample radar signature of an object (semi-truck) at a fixed range.

FIG. 10C is a sample radar signature of an object (automobile) at a fixed range.

FIGS. 11A and 11B illustrate the latitude, longitude and heading of a target.

FIGS. 12A-12D illustrate the steps for a method in setting the origin of the target.

FIGS. 13A-13D illustrate the steps for a method in setting the origin of the target.

### 6.0 DETAILED DESCRIPTION

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

The following list of example features corresponds with the attached figures and is provided for ease of reference, where like reference numerals designate corresponding features throughout the specification and figures:

Measurement Cart 5
Mobile Platform 10
Driven Wheels 15
Steered Wheels 20
Mast 25
Wireless Antenna 30
GPS Module 35
Support Post 40
Inertial Measurement Unit (IMU) 45
Characteristics Sensor 50
Sensor Arm 51
Sensor Arm Bracket 52
Adjustment Knob 53
Ruler 54
Adjustment Pin 55
Pin 56
Holes 57a, 57b, 57c
Height Adjustment of the Characteristics Sensor Position 60
Rotational Adjustment of the Characteristics Sensor Position 62
Computer (Tablet) 65
Wireless Signal 68
Steering Knuckle 70
Tie Rod 75
Steering Actuator 80
Plug Panel 81
Top Surface of Mobile Platform 83
Support Post Socket 84-1
Mast Socket 84-2
Cart Processor 85
Battery 90
Motor 95
Subject Vehicle/Target 100
Cart Path 105a
Cart Path 105b
Reading Start Position (1) 120a
Reading Start Position (2) 120b
Reading Start Position (3) 120c
View Angle for Start Position (1) 125a
View Angle for Start Position (2) 125b
View Angle for Start Position (3) 125c
External Processor 130
Wired/Wireless Signals 132
Various Features and Parameters Associated with the Cart Software
7-02 through 7-80.

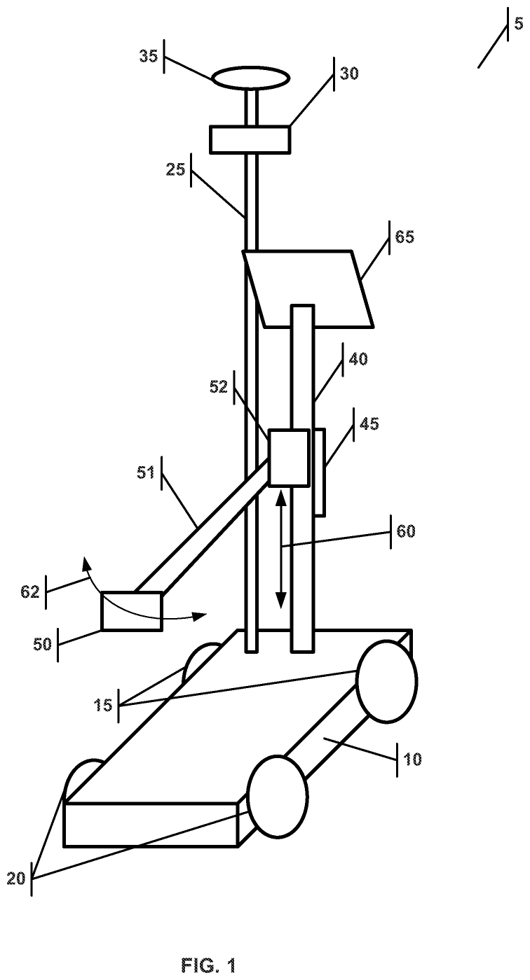

FIG. 1 illustrates a measurement cart 5, which includes a mobile platform 10 with driven wheels 15 and steered wheels 20. As discussed further below the cart 5 may be fully automatic or semi-automatic. Extending from the mobile platform 10 is a mast 25 upon which a wireless antenna 30 and at least a portion of the GPS module 35 may be mounted. The GPS module 35 may include an antenna and a receiver, the antenna portion may be mounted on the mast 25. Also extending from the mobile platform is a support post 40, upon which are mounted an inertial measurement unit (IMU) 45, an adjustable sensor bracket 52 and a computer (tablet) 65. The GPS receiver portion of the GPS module 35 may be integrated with the IMU 45. Extending from the adjustable sensor bracket 52 is a sensor arm 51 with a characteristics sensor 50 mounted to it. The characteristics sensor 50, may include one or more characteristics sensors. The sensor bracket 52 permits height adjustment of the characteristics sensor position (arrow 60) and rotational adjustment of the characteristics sensor position (arrow 62). While the cart 5 is shown with a mast 25 and a support post 40, these two structures may be integrated into a single structure. Also the location and mounting of the various components (wireless antenna 30, GPS module 35, IMU 45, the sensor arm bracket 52, the computer 65, etc.) can be changed without deviating from the invention. As a non-limiting example, the GPS antenna may be mounted on the mast 25, while the GPS receiver is mounted within the mobile platform 10.

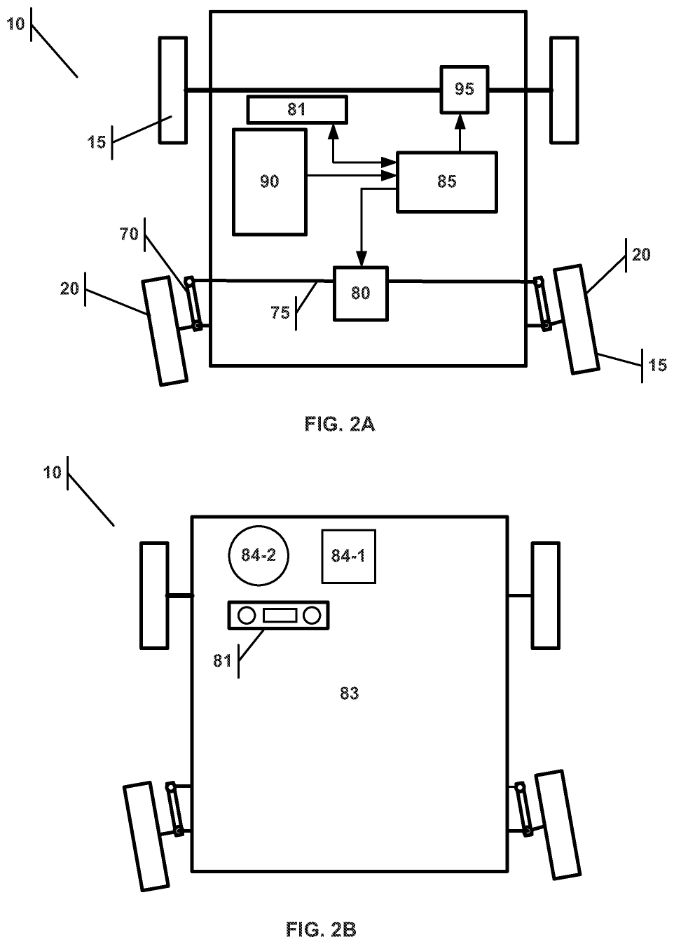

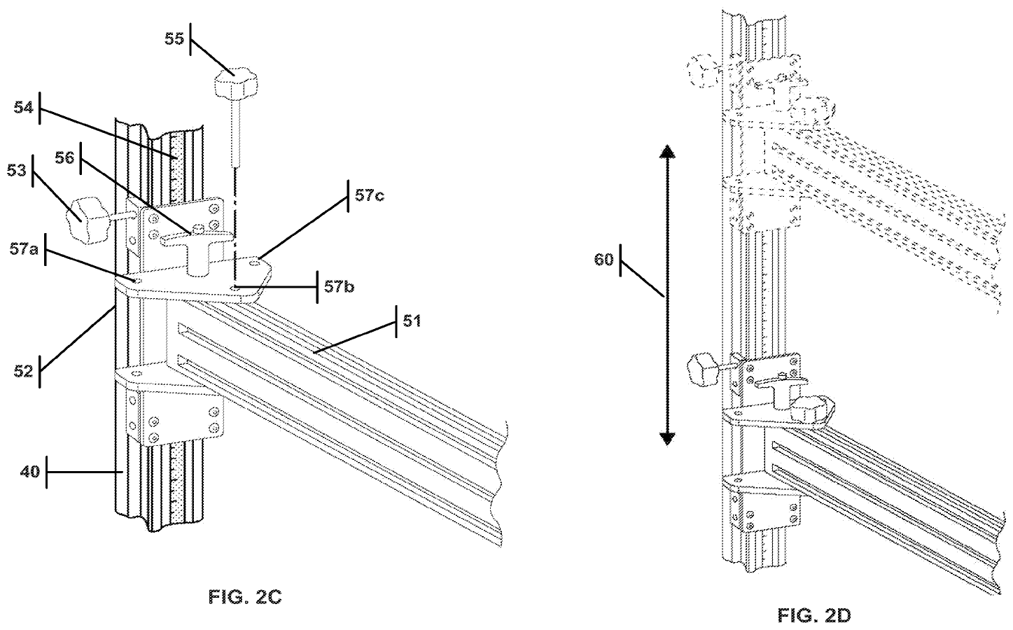

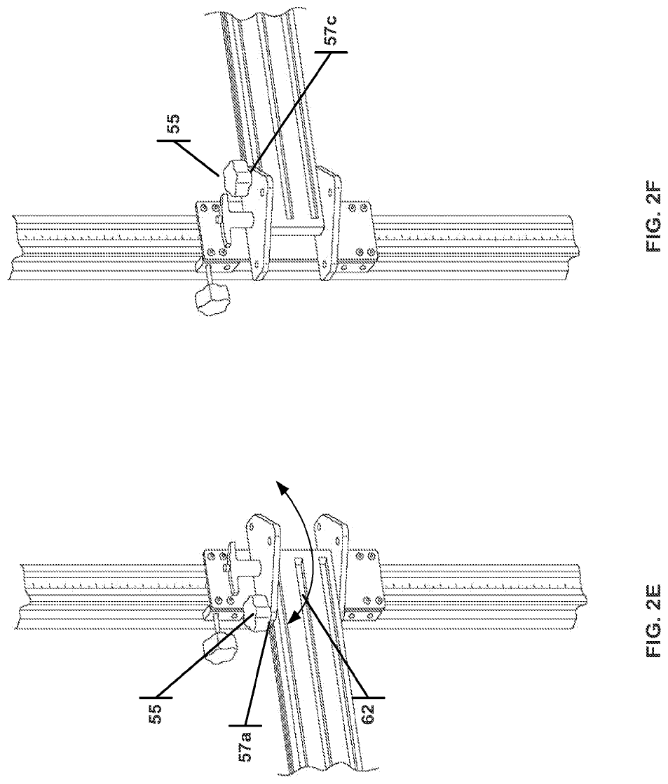

The GPS module 35 provides location data to the cart processor 85. The IMU 45 measures and reports to a cart processor 85 (see FIG. 2A) the acceleration, orientation, angular rates, and other gravitational forces of the cart. It is composed of 3 accelerometers, 3 gyroscopes, and depending on the heading requirement—3 magnetometers.

FIG. 2A illustrates the internal components of the mobile platform 10. The cart processor 85 may be connected to a battery 90, motor 95, and steering actuator 80. Motor 95 is connected to the driven wheels 15. The steering actuator is connected to tie rod 75, which engages steering knuckles 70, allowing wheels 15 to be steered. The cart processor 85 can therefor control the movement of the mobile platform 10. The cart processor 85 may be connected to plug panel 81, which allows exterior components to connect to the cart processor 85. For example, the GPS module 35, the wireless antenna 30, the IMU and the characteristics sensor 50 may plug into the plug panel 81, thus completing the connection to the cart processor 85. Other connections on the plug panel 81 may include, but are not limited to power and Ethernet. FIG. 2B illustrates the top surface of the mobile platform 83, with the plug panel 81. The surface 83 may also include a support post socket 84-1 into which the support post 40 may be inserted and detachably secured, and a mast socket 84-2 into which the mast 25 may be inserted and detachably secured. Detaching the mast 25 and support post 40 from the mobile platform 10 may be used to transport the cart in a more compact form.

Referencing FIG. 2C, the height and rotational adjustability of the sensor arm 51, through the sensor arm bracket 52 is shown. The height may be changed to provide a more robust and accurate characteristics sensor reading of the target, while the rotation may be adjusted when taking a fixed angle or fixed range measurements (discussed below). For height adjustment shown in FIG. 2D, adjustment knob 53 is untightened, and the bracket 52 may then slide up or down (arrow 60) along the support post 40. A ruler 54 may be included to make more precise and repeatable adjustments. For rotational adjustment shown in FIGS. 2E and 2F, adjustment pin 55 is removed, allowing the sensor arm 51 to rotate about pin 56. Once rotated, the adjustment pin 55 may be inserted into hole 57a on the bracket 52 (shown in FIG. 2E) or into hole 57c (shown in FIG. 2F). As shown there are three holes (57a, 57a, 57b), thus there are three rotational position. More or fewer holes may be used. Pin 56 and adjustment pin 55 may be removed, allowing the sensor arm 51 to detach completely from the bracket 52. This may be done during breakdown and storage of the cart.

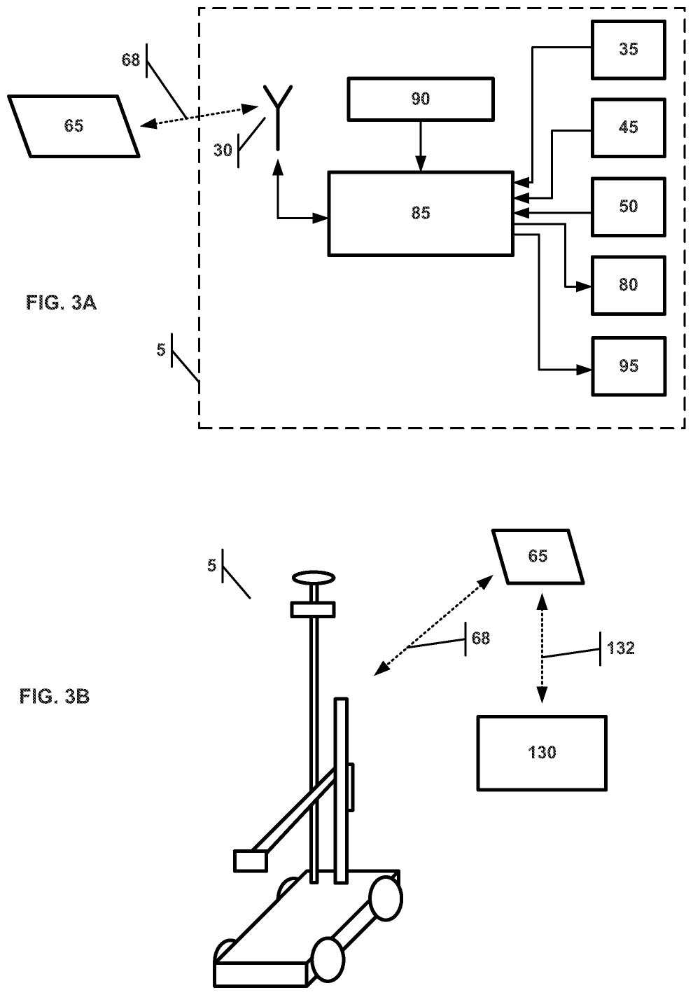

FIG. 3A is a schematic showing the various connected between the components, where the cart processor 85 and the computer 65 are separated. The cart is denoted as the dashed box 5 around the components that are on the cart. The cart processor 85 may have input connection from the GPS module 35, the IMU 45, and the senor 50. The cart processor 85 may control the steering actuator 80 and the motor 95. Power is provided by battery 90. The computer (tablet) 65 may control the cart processor 85 through a wireless antenna 30 that receives a data signal 68. The computer (tablet) 65 may be connected to an external processor 130 via wired/wireless signal 132. The external processor 130 may be used to download and process data obtained by the computer (tablet) 65 that was originally generated from the cart 5. This is shown in FIG. 3B. While an external processor 130 shown, the computer (tablet) 65 may be used to fully or partially process the data originated by the cart 5.

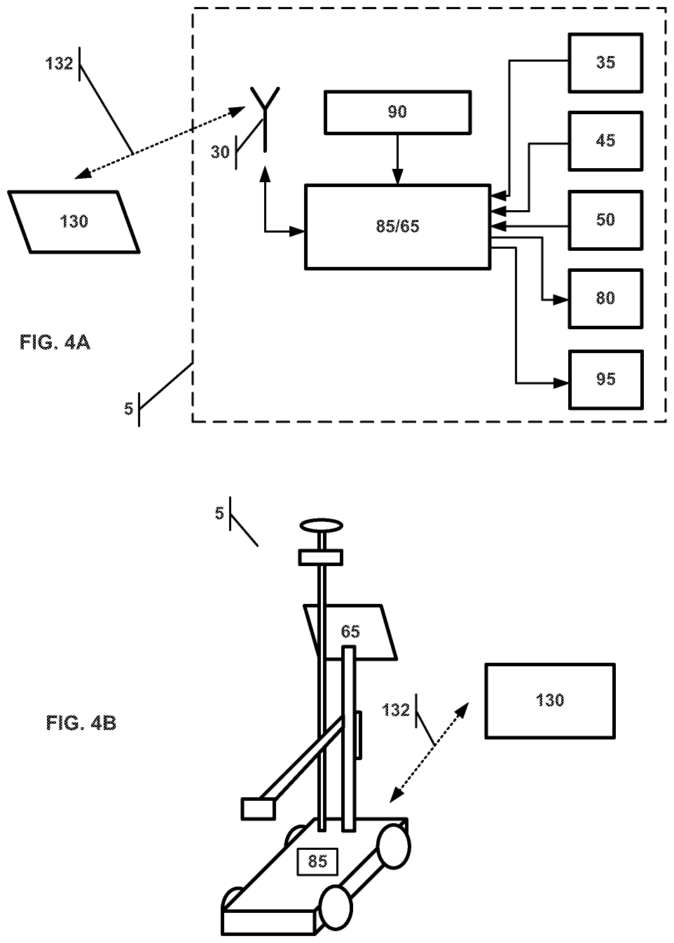

4A is a schematic showing the various connected between the components, where the cart processor 85 and the computer 65 are integrated in the cart 5. The cart is denoted as the dashed box 5 around the components that are on the cart. The cart processor 85 may have input connection from the GPS module 35, the IMU 45, and the senor 50. The cart processor 85 may control the steering actuator 80 and the motor 95. Power is provided by battery 90. The computer (tablet) 65 may control the cart processor 85. The computer (tablet) 65 may be connected to an external processor 130 via wired/wireless signal 132 (a wireless communication is illustrated). The external processor 130 may be used to download and process data obtained by the computer (tablet) 65 that was originally generated from the cart 5. This is shown in FIG. 4B. While an external processor 130 shown, the computer (tablet) 65 may be used to fully or partially process the data originated by the cart 5. Also, while in FIG. 4A the computer 65 and cart processor 85 are shown in single block, these two devices may be part of the cart but integrated through a data connection. For example, the computer 65 may be mounted on the support post and in data communication with the cart processor 85 (such as a servo controller).

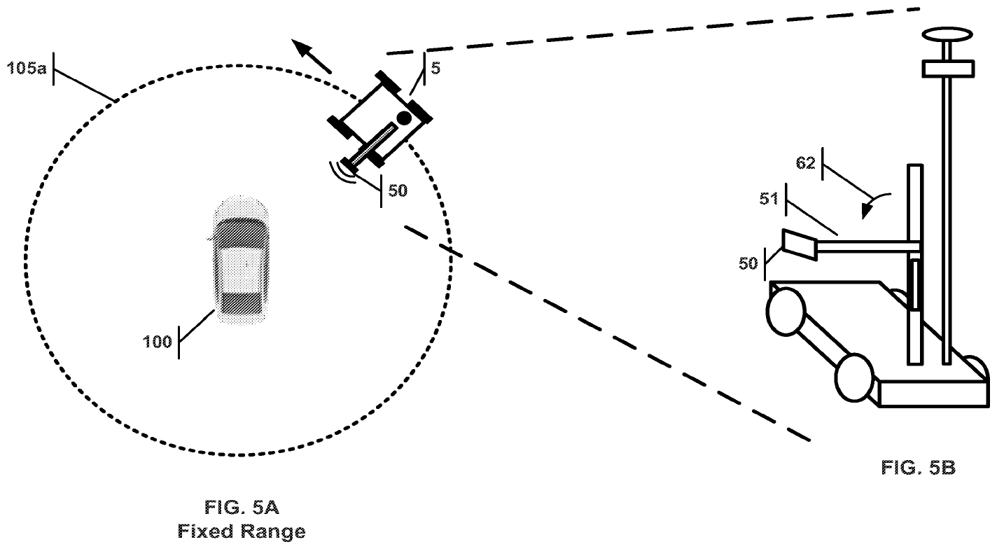

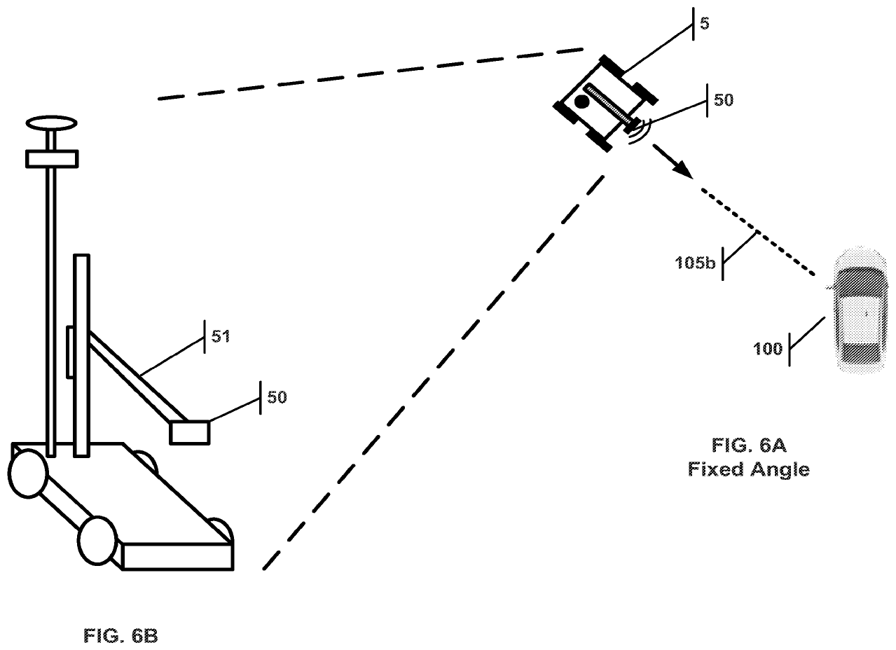

The cart 5 may be used for at least two different measurements. The first is fixed range shown in FIG. 5A. The cart 5 travels in a circular cart path 105a around a subject vehicle/target 100. As shown in FIG. 5B, for this measurement the cart 5 has the sensor arm 51 rotated 90 degrees from the position shown in FIG. 1. This places the senor 50 pointing at the subject vehicle/target 100 during data collection. The second measurement is shown in FIG. 6A. The cart travels in a straight cart path 105b at the subject vehicle/target 100. As shown in FIG. 6B, for this measurement the cart 5 has the sensor arm 51 in the same position as shown in in FIG. 1. This places the senor 50 pointing at the subject vehicle/target 100 during data collection.

Both of these measurements may be done semi-automatically and fully automatically. The computer 65 may run software to implement the semi-automatic and fully automatic data collection. As previously describe with reference to FIGS. 3A and 3B, the computer 65 may communicate with the cart 5 through a wireless connection. In this embodiment, the user may disconnect the computer 65 and monitor the status of the cart 5 data as it collects data. As shown in FIGS. 4A and 4B, the computer 65 may be integrated with the cart processor. In this embodiment, the user may set up the path and allow the cart 5 to operate automatically or semi-automatically. It should be noted that the control and monitoring may be assigned partially or completely to the cart 5 or to a computer remote from the cart 5.

In the semi-automatic mode, the cart processor is connected to the steering actuator, characteristics sensor, GPS module and IMU. The cart processor may perform the following steps: (a) move the steering actuator based on data generated from the GPS module and data generated from the IMU; and (b) record data generated from the characteristics sensor. In this mode, the user provides the propulsion. In the fully automatic mode, the cart additionally may actuate the motor to provide propulsion based on location data generated from the GPS module and data generated from the IMU, to maintain the cart on the path calculated by the computer.

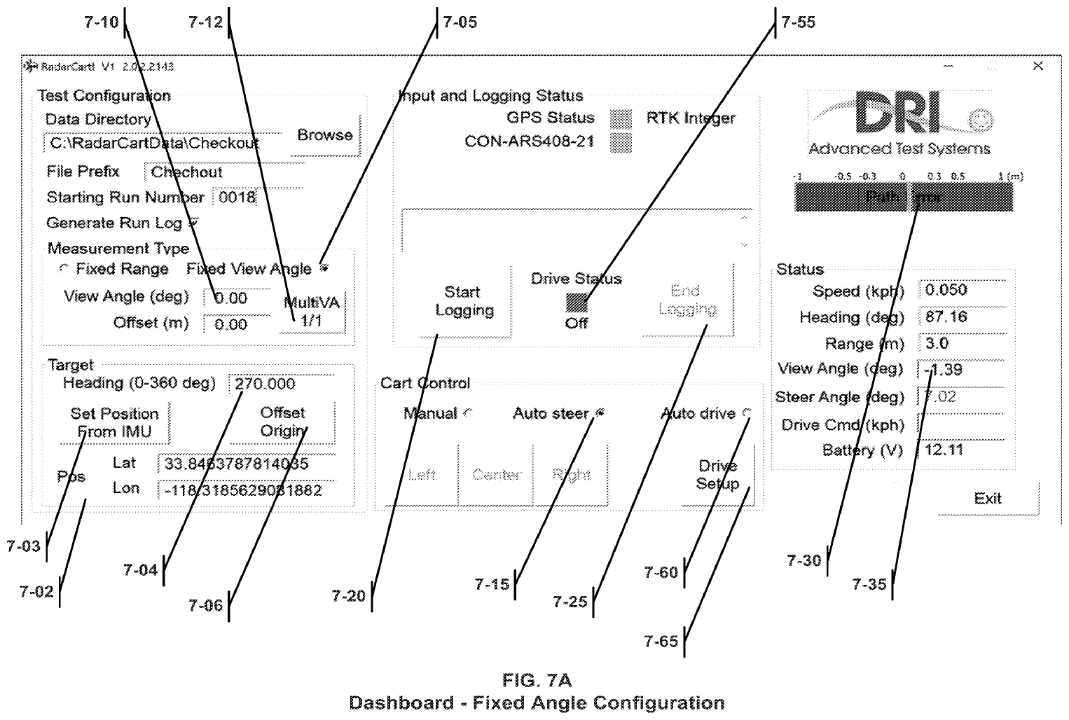

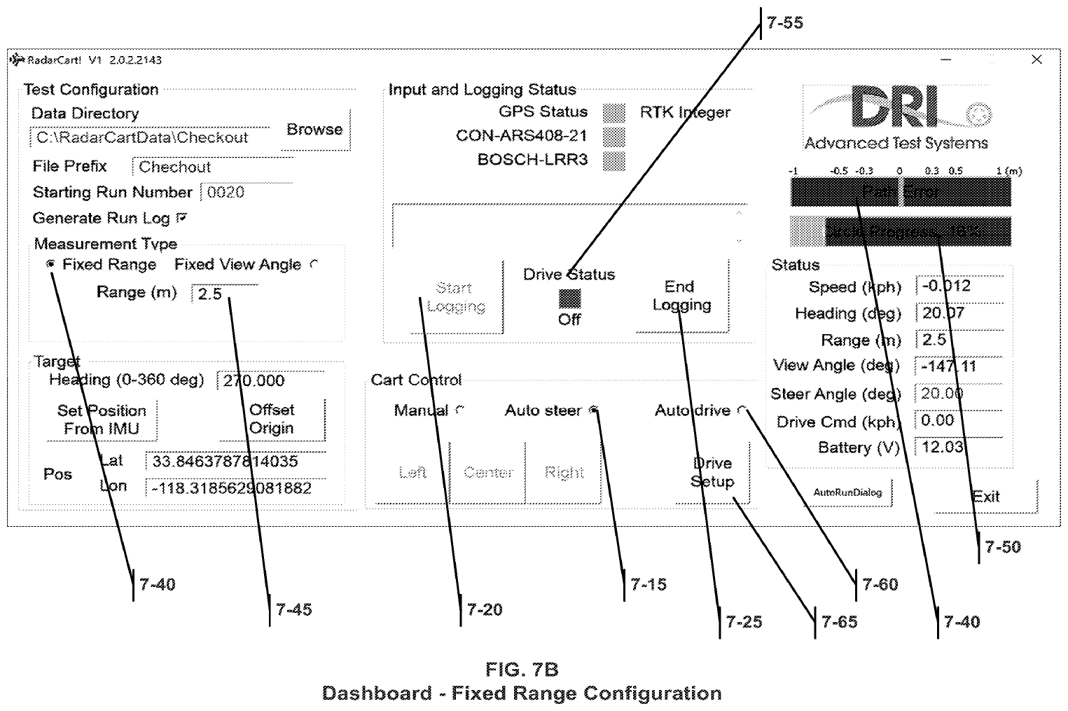

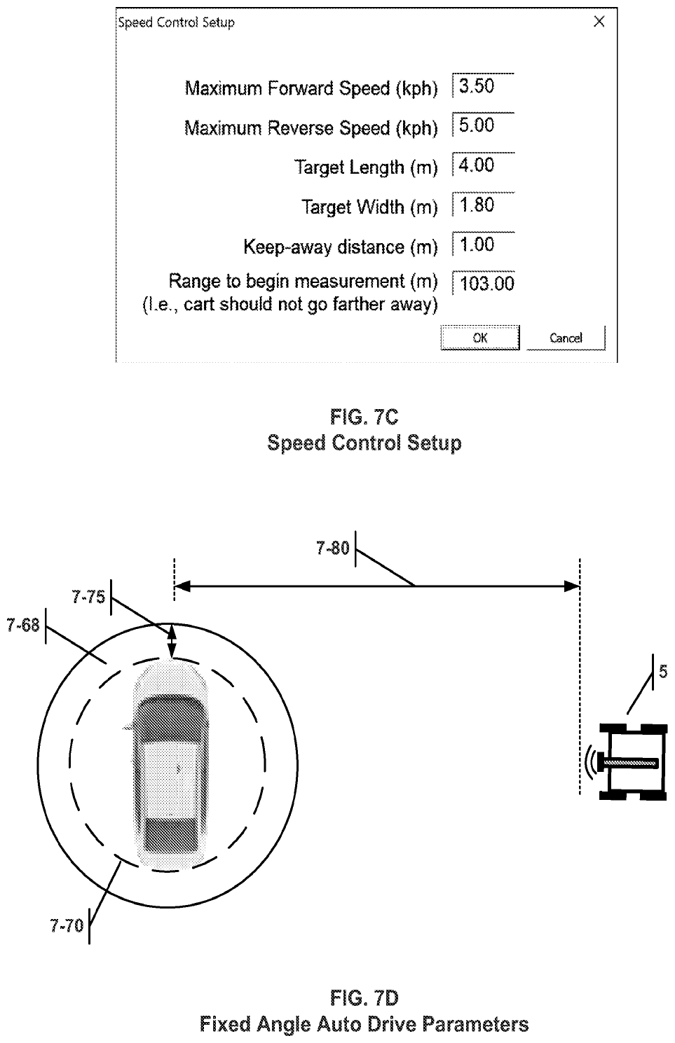

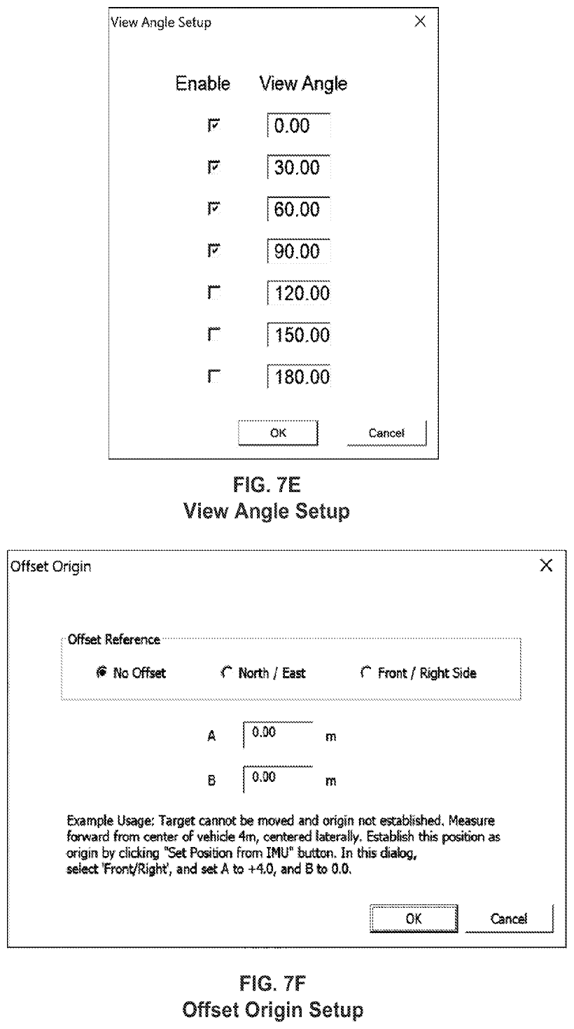

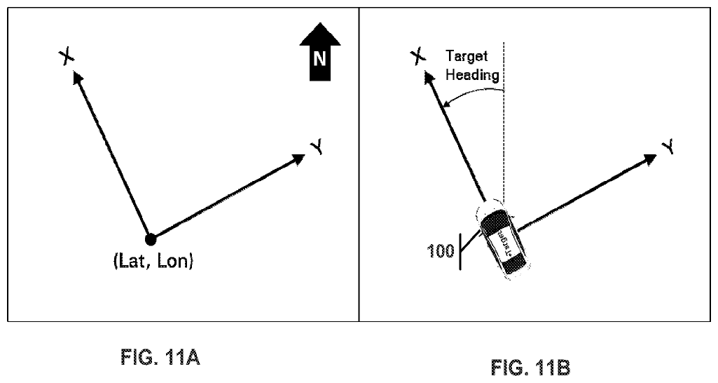

For the software to function correctly, the location of the center of the target, referred to as the Origin, and the heading of the target must be known. This section describes alternative methods to set the target origin and heading. Select the method that best fits the user's application. In method one, a local coordinate system is used where a spot is permanently marked on the surface with a known latitude, longitude, and heading. If this is the case, then target setup is as follows: (1) Place the target on the origin with its heading aligned with the x-axis (see FIGS. 11A and 11B illustrating these parameters); and (2) In the cart operation software, enter the Lat and Lon angles and the heading within the target panel (see 7-02, FIG. 7).

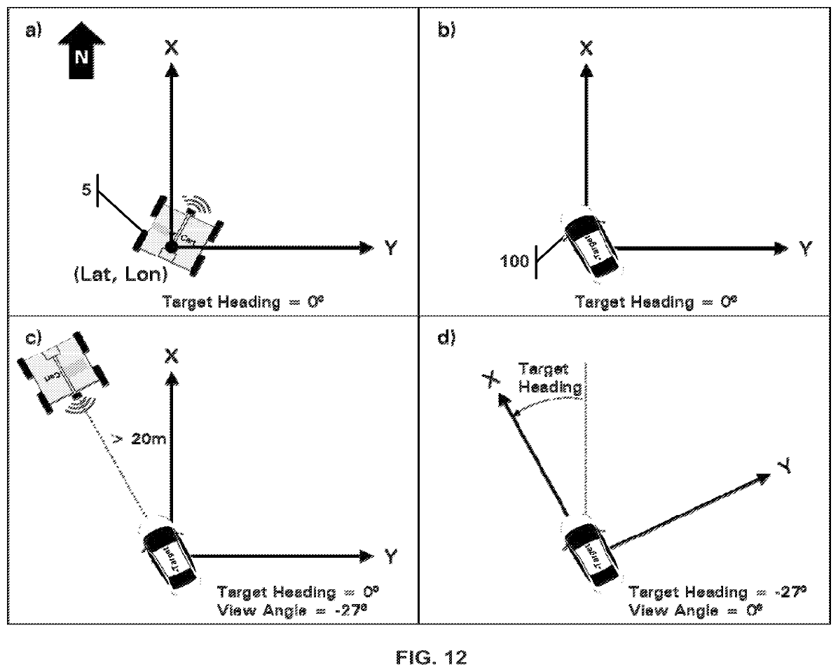

Method two may be used if the user wants to place the origin at an unmarked location. This is only applicable if it is possible to put the cart on the origin. If the target is already on top of the origin and cannot be easily moved, use method three below:
1. Position the cart so the sensor arm pivot point is over the desired origin location.
2. Press “Set Position From IMU” in the Target panel on the GUI (see 7-03, FIG. 7A), which will automatically copy the current latitude and longitude into the Lat and Lon fields. (FIG. 12A)
3. Position the target so its center is on the origin and set the Heading field in the Target panel to “0.” (FIG. 12B; 7-04, FIG. 7A)
4. Move the cart so it is directly in front of the target (i.e., 0 degrees of View Angle). Note that the further away the cart is from the target, the more accurate the heading will be. (FIG. 12C)
5. Read the number indicated in the “View Angle (deg)” (7-35, FIG. 7A) field of the IMU Status panel and enter that as the Target Heading (7-04, FIG. 7A). The View Angle should now be zero. (FIG. 12D)
   Note that if you know the target heading very accurately it can be directly entered and steps 4 and 5 can be skipped.

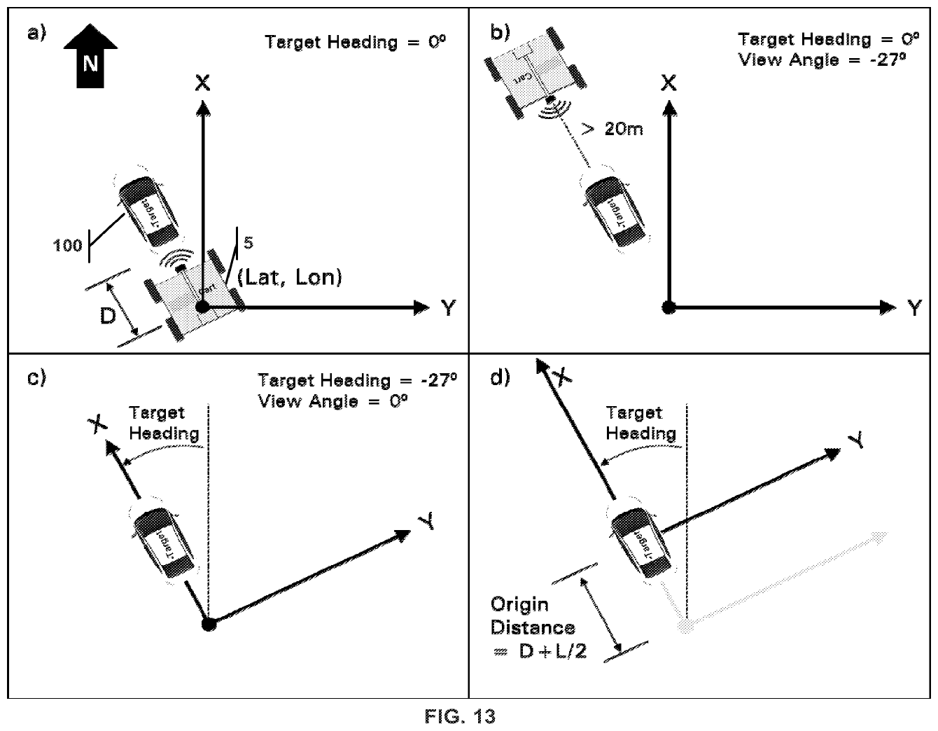

Method three uses the target's current position to set the origin:
1. Position the cart so it is directly behind the target but facing the same direction as the target.
2. Press “Set Position From IMU” in the Target panel on the GUI (7-03, FIG. 7A), which will automatically copy the current latitude and longitude into the Lat and Lon fields.
3. Measure the distance from the sensor arm pivot point on the cart to the rear of the Target.
4. Set the Heading field in the Target panel to “0.” (FIG. 13A; 7-04, FIG. 7A)
5. Move the cart so it is directly in front of the target (i.e., 0 degrees of View Angle). Note that the further away the cart is from the target, the more accurate the heading will be. (FIG. 13B)
6. Read the number indicated in the “View Angle (deg)” (7-35, FIG. 7A) field of the IMU Status panel and enter that as the Target Heading (7-04, FIG. 7A). The View Angle should now be zero. (FIG. 13C)
7. Calculate the forward offset distance using the equation below:

Offset Distance=(Distance from step 3)+(Target Length)/2
8. Press the “Offset Origin” button in the Target panel on the GUI. (7-06, FIG. 7A), which will bring up the Offset Origin screen shown in FIG. 14.
9. Select “Front/Right” and enter the offset distance from step 7 into the “A” field and enter “0” into the B field. Press OK. (FIG. 13D) This last step will shift the origin from a location some distance behind the target to the center of the target.

### 6.1 SEMI-AUTOMATIC MODE WITH MANUAL PROPULSION

FIG. 7A is a screenshot of the cart's operational software dashboard in the Fixed Angle configuration. To make measurements in this configuration, the following steps may be used in the software:
1. Set the Measurement Type to “Fixed View Angle” (7-05) and confirm the sensor arm is forward (see FIGS. 6A and 6B).
2. Enter the desired view angle (7-10).
3. Manually position the cart so it is near the path and pointing towards the target.
4. Set the Steering Control mode to Automatic (7-15).
5. Set the characteristics sensor height to the desired position.
6. Move the cart to the desired starting range (the cart will automatically steer)
7. Press “Start Logging” (7-20)
8. Move the cart to the desired ending range.
9. Press “End Logging” (7-25)
10. Repeat steps 5-9 for repeated measurements.

The characteristics sensor data, along with the associated position information, is logged onto the computer (tablet) 65, which either processes that data partially or fully, or transfers the data to a separate external processor 130 for processing.

The “Offset” field can be used to apply a path offset. This can be used, for example, to take a measurement of the rear of an object but when approaching from an adjacent lane. In this example, the offset should be set to one lane width.

When manually positioning the cart, the user should ensure it is close to the desired path (and view angle) and generally pointing at the target. The user can determine if they are near the desired path by confirming that the path error is small (as shown in the Path Error indicator (7-30). Additionally, the user can see the View Angle (7-35) displayed in the Status panel.

When in Automatic steering mode, the cart will acquire and follow the desired path regardless of the direction of travel (forward or backwards). The Fixed-Angle measurements can be performed while moving towards or away from the target.

FIG. 7B is a screenshot of the cart's operational software dashboard in the Fixed Range configuration. To make measurements in this configuration, the following steps may be used in the software:
1. Set the Measurement Type to “Fixed Range” (7-40) and confirm the sensor arm is pointing left (see FIGS. 5A and 5B).
2. Enter the desired range (7-45).
3. Manually position the cart so it is at the correct range and the characteristics sensor is pointing towards the target. This can occur at any point around the circle.
4. Set the Steering Control (7-15) mode to Automatic.
5. Set the characteristics sensor height to the desired position.
6. Move the cart around the circle in the anti-clockwise direction until the path error (7-30) is steady at less than 0.1 m (the cart will automatically steer)
7. Press “Start Logging.” (7-20) The Circle Progress (7-50) indicator will reset to 0%.
8. Move the cart around the circle until the Circle Progress (7-50) reaches 100%. It will reset back to 0% after reaching 100%.
9. Press “End Logging” (7-25)
10. Repeat steps 5-9 for repeated measurements.

When manually positioning the cart, ensure it is close to the desired path (i.e., range) and generally pointing at the target. The user can determine if they are near the desired path by confirming that the path error is small or that the range value, displayed in the Status panel, is correct.

When in Automatic steering mode, the cart will acquire and follow the desired path regardless of the direction of travel (forward or backwards). The Fixed-Range measurements may be performed while moving around the target in an anti-clockwise direction.

### 6.2 AUTOMATIC MODE WITH AUTOMATIC PROPULSION

If the Auto Drive feature is enabled, then the cart is capable of both steering and propelling itself in order to perform characteristic measurements. The operator does not need to push the cart but should be in possession of the tablet computer and should be close enough to the cart to maintain a consistent wireless communication signal.

The Drive Status indicator (7-55) indicates the state. To engage the Auto Drive feature, set the Cart Control to Auto Drive (7-60). The drive status will only be “Ready” if the cart is within a predetermined distance from the path and pointing in the general direction of the path. Once the drive state is “Ready” the user can initiate the measurement by pressing the “Start Logging” (7-20) button. Note that the cart will do automatic steering when in Auto Drive, even if the drive state is “Not Ready.”

The Drive Setup button (7-65) will open the Speed Control Setup parameters window (see FIG. 7C). The parameters are described in Table 1. The forward speed is used when measuring. The forward speed will affect how many measurements are collected over the measurement distance and should be set accordingly. Note that setting the forward or reverse speeds too high may result in steering control instability. The remaining parameters are only applicable to the Fixed-Angle measurement and are further described below.

TABLE 1
Auto Drive Setup Parameter Descriptions

| Parameter | Description | Units |
|---|---|---|
| Maximum Forward | Forward speed when measuring | kph |
| Speed | | |
| Maximum Reverse | Reverse speed when positioning for next | kph |
| Speed | measurement | |
| Target Length | Length/Width of the object being measured | m |
| Target Width | (used to determine how close to get to the | m |
| | target) | |
| Keep-away distance | Minimum distance to the object being | m |
| | measured | |
| Range to begin | Distance to start measurements | m |
| measurement | | |

To use the Auto Drive function for the Fixed Range configuration, the following steps may be used in the software:
1. Position the cart near the desired path and pointing in the general direction of travel.
2. Switch the Cart Control to Auto Drive (7-60).
3. Walk the cart forward until the Drive Status (7-55) is “Ready” and the cart is sufficiently on the path to begin measuring.
4. Press “Start Logging” (7-20).

The cart will drive forward and will stop after it completes one circle. The logging will stop automatically. The cart software calculates the path and the cart processor actuates the steering actuator and motor to maintain upon this path, using data from the GPS module and IMU.

To use the Auto Drive function for the Fixed Angle configuration, it is important to properly set the Auto Drive Parameters (FIG. 7C) for the Fixed-Angle measurements to ensure the cart does not collide with the object being measured or back up further than what is safe. A circular area 7-68 (shaded in FIG. 7D) around the object is defined based on the object length and width (7-70) as well as a keep-away distance (7-75). When moving forward, the cart will stop before reaching this area 7-68 as depicted in FIG. 7D. When reversing, the cart will begin to stop when it reaches the “Range to begin measurement” distance (7-80).

When using the drive feature, the operator may specify multiple different view angles to measure. The cart will perform these measurements consecutively, without operator interaction. The current View Angle is shown in the GUI (item 7-10 in FIG. 7A). The MultiVA button 7-12 indicates the current view angle number and the total number of selected view angles. For example, if the button indicates “1/1” the cart will measure the first view angle of the one selected. As another example, if the button indicates “2/4” then the second angle out of four is being measured. Pressing the MultiVA button will open the View Angle Setup window (FIG. 7E). The check boxes enable/disable each view angle and the angle can be edited.

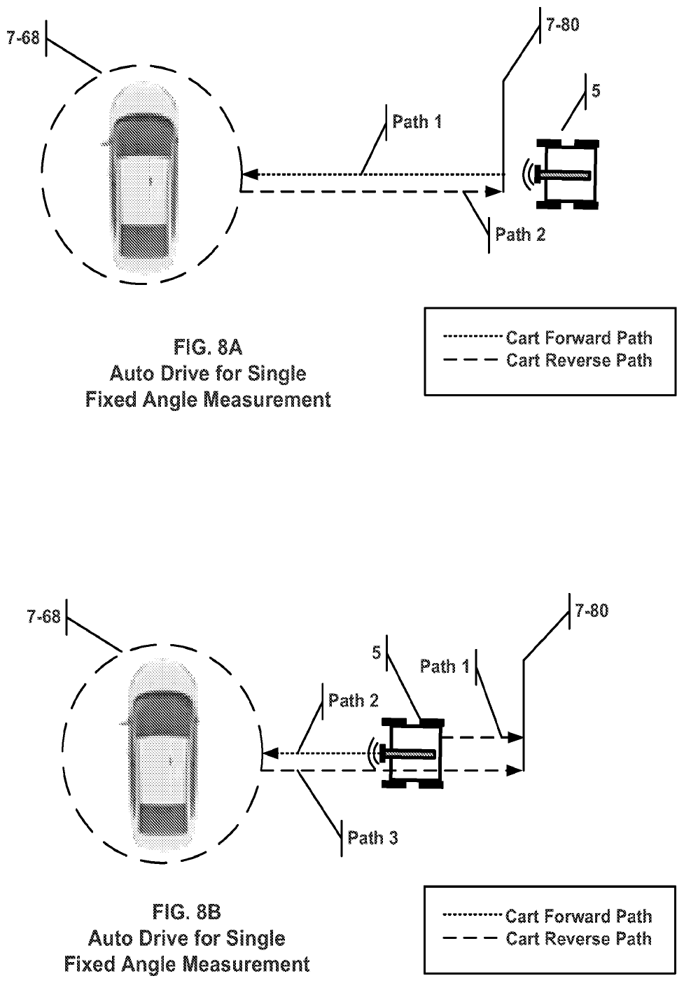

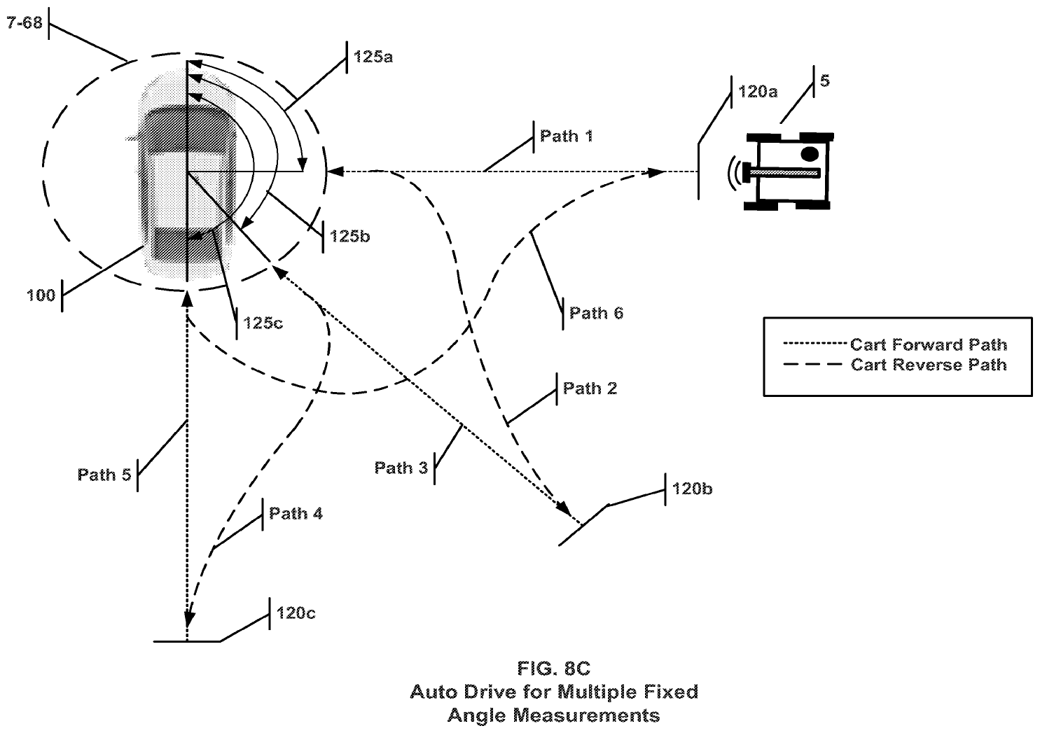

To perform a Fixed-Angle measurement of one view angle (i.e., where only one view angle is enabled), position the cart near the path to get the Drive Status (7-55) and press “Start Logging” (7-60). If the cart range is less than the Start Distance (7-80) it will first reverse to the start distance. It will then drive forward to perform the measurement and then reverse to the start distance in preparation for another measurement. The operator can abort at any time by pressing the “End Logging” button (7-25) illustrates the two paths for a single view angle measurement when the cart starts near the Start Distance. FIG. 8B illustrates the three paths where the cart starts away from the Start Distance.

The cart can perform multiple Fixed-Angle measurements back-to-back if more than one view angle is enabled. In this case, after the first measurement is complete the cart will reverse along the path of the next view angle until it reaches the Start Distance. This pattern will continue until all view angles have been measured at which point the cart will reverse back to the Start Distance of the first view angle. An example of this process with three (3) view angles is illustrated in FIG. 8C where the cart follows paths 1 through 6 in sequential order, where start position 120a corresponds view angle 125a (90 degrees), start position 120b corresponds view angle 125b (135 degrees), and start position 120c corresponds view angle 125c (180 degrees). This setup results in three measurements at 90, 135 and 180 degrees. Had the cart started closer than the Start Distance, it would have first reversed along the path 1 to start position 120a.

As with the fixed-range Auto Drive, the cart software calculates the path and the cart processor actuates the steering actuator and motor to maintain upon this path, using data from the GPS module and IMU.

The computer and/or the external processor may use the characteristics sensor data to generate a file representing the characteristic signature of the object. The file is a two dimensional or three dimensional representation of the object, based on the characteristic data measured by the characteristics sensor—i.e., radar, LiDAR, ultra-sonic and near/far infrared.

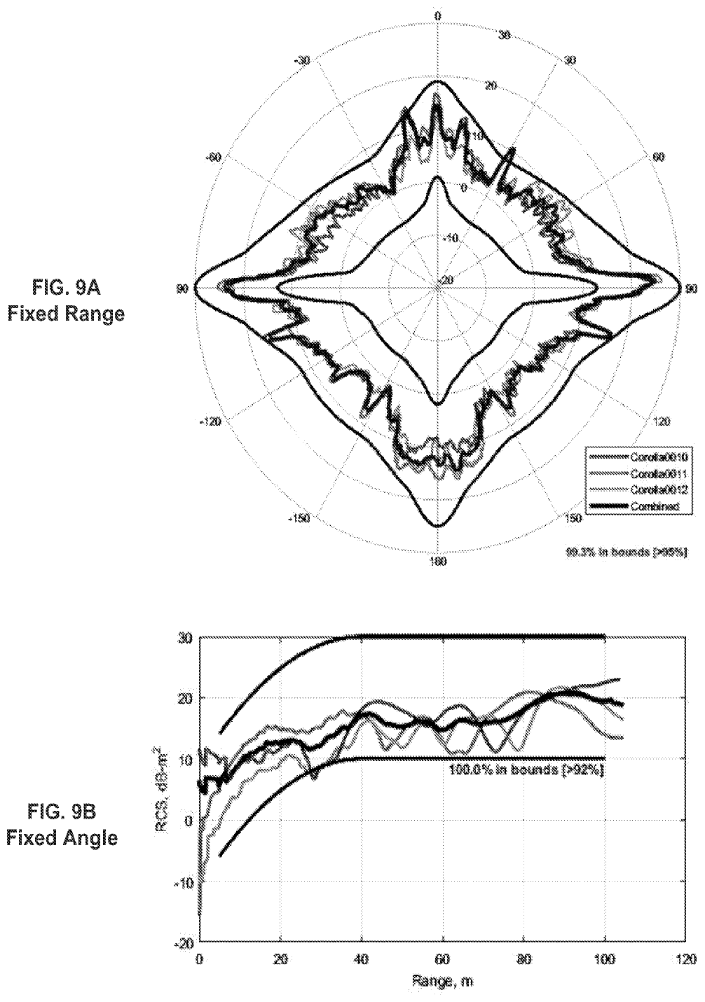

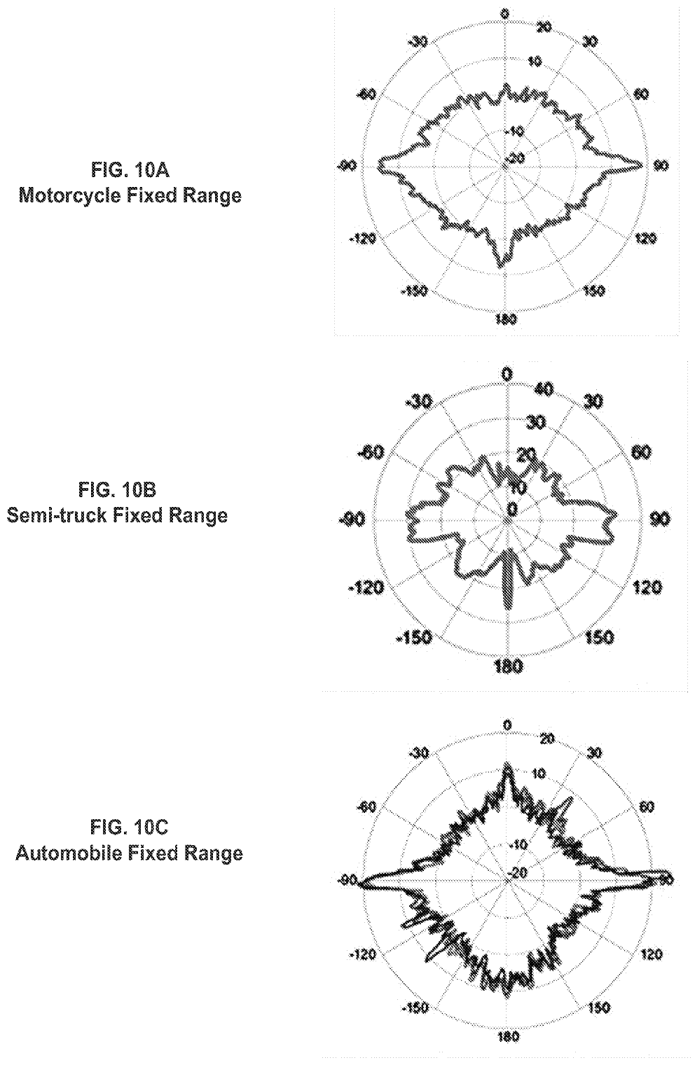

The file may be a radial graph. For example, FIG. 9A is a sample signature for the radar characteristic of a subject vehicle at a fixed range. FIG. 9B is a sample radar signature of a subject vehicle at a fixed angle. FIGS. 10A-10C are sample radar signatures of a motorcycle, semi-truck and automobile, respectively, at a fixed range. The post-processing may merge the fixed angle and fixed range measurements into a multi-dimensional matrix.

The characteristics sensors described above may be radar, LiDAR, ultra-sonic and near/far infrared sensors. It is particularly advantageous to mount multiple characteristics sensors on the cart to obtain signatures for more than one characteristic simultaneously.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus it is to be understood that the description and drawings presented herein represent a presently-preferred embodiment of the invention and are therefore representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

1. A system for measuring a characteristic signature of an object, the system comprising:
a computer in data communication with a cart processor, the computer constructed to calculate a path;
a measurement cart comprising:
a mobile platform comprising a steering actuator connected to a steered wheel and a motor connected to a driven wheel;
a characteristics sensor directed at the object, the characteristics sensor comprising at least one of a radar, LiDAR, ultra-sonic or near/far infrared sensor;
a GPS module;
the cart processor constructed to:
control the motor and steering actuator;
receive data from the characteristics sensor and GPS module; and
perform the following steps;
a. actuate the steering actuator based on location data generated from the GPS module and the calculated path;
b. actuate the motor based on location data generated from the GPS module and the calculated path; and
c. record data generated from the characteristics sensor.

2. The system of claim 1, where the computer is integrated into the cart.

3. The system of claim 1, wherein the characteristics sensor is at a fixed angle relative to the object during at least a portion of the calculated path.

4. The system of claim 1, wherein the characteristics sensor is at a fixed range relative to the object during at least a portion of the calculated path.

5. The system of claim 1, wherein the computer accesses the data from the cart processor, and the computer processes the data to generate a file representing the characteristic signature of the object.

6. The system of claim 1, wherein:
the computer accesses the data from the cart processor and transfers the data to an external processor; and
the external processor processes the data to generate a file representing the characteristic signature of the object.

7. The system of claim 1, wherein the computer is in wireless data communication with the cart processor.

8. The system of claim 1, wherein the characteristics sensor comprises a height adjustment and/or a rotational adjustment.

9. The system of claim 1, wherein the cart further comprises an inertial measurement unit (IMU) connected to the cart processor, and steps (a) and (b) are based on data from the IMU.

10. The system of claim 1, further comprising a mast extending from the mobile platform, wherein at least a portion of the GPS module mounts to the mast.

11. The system of claim 1, further comprising a support post extending from mobile platform, wherein the computer detachably mounts to the support post.

12. The system of claim 11, further comprising a sensor arm bracket slidably attached to the support post, and a sensor arm attached to the sensor arm bracket, wherein the characteristics sensor is attached to the sensor arm.

13. The system of claim 1, wherein the characteristics sensor comprises a plurality of characteristics sensors, and step (c) comprises recording data generated from the plurality of characteristics sensors simultaneously.

14. The system of claim 1, wherein the cart further comprises a battery connected to the cart processor.

15. A measurement cart for measuring a characteristic signature of an object, the cart comprising:
a mobile platform comprising a steering actuator connected to a steered wheel;
a characteristics sensor comprising at least one of a radar, LiDAR, ultra-sonic or near/far infrared sensor;
a GPS module;
an inertial measurement unit (IMU);
a cart processor constructed to:
control the steering actuator;
receive data from the characteristics sensor, GPS module and IMU; and
perform the following steps;
a. actuate the steering actuator based on data generated from the GPS module and data generated from the IMU; and
b. record data generated from the characteristics sensor.

16. The cart of claim 15, wherein the mobile platform comprises a driven wheel, the cart further comprising:
a motor connected to the cart processor and constructed to drive the driven wheel;
wherein the cart processor is constructed to perform the following additional steps:
c. actuate the motor based on location data generated from the GPS module and data generated from the IMU.

17. The cart of claim 16, further comprising:
a computer in data communication with the cart processor, the computer constructed to calculate a path;
wherein the cart processor performs steps (a) and (c) based on the path.

18. The cart of claim 17, wherein the computer is integrated into the cart.

19. The cart of claim 17, wherein the computer is in wireless data communication with the cart processor.

20. The cart of claim 15, wherein the characteristics sensor is at a fixed angle relative to the object during at least a portion of step (b).

21. The cart of claim 15, wherein the characteristics sensor is at a fixed range relative to the object during at least a portion of step (b).

22. The cart of claim 15, wherein the characteristics sensor comprises a height adjustment and/or a rotational adjustment.

23. The cart of claim 15, further comprising a mast extending from the mobile platform, wherein at least a portion of the GPS module mounts to the mast.

24. The cart of claim 15, further comprising a battery connected to the cart processor.

25. The cart of claim 15, wherein the characteristics sensor comprises a plurality of characteristics sensors, and step (b) comprises recording data generated from the plurality of characteristics sensors simultaneously.

26. A method for measuring a characteristic signature of an object using a measurement cart comprising a mobile platform with automatic steering and a characteristics sensor, the characteristics sensor comprising at least one of a radar, LiDAR, ultra-sonic or near/far infrared sensor, the method comprising:
a. set the origin of the object;
b. provide a path;
c. point the characteristics sensor at the object;
d. propel the mobile platform, while the mobile platform is steered automatically based on the path;
e. record data from characteristics sensor.

27. The method of claim 26, wherein the mobile platform comprising automatic propulsion, and step (d) is done automatically.

28. The method of claim 26, wherein the propulsion is provided by a user.

29. The method of claim 26, wherein the mobile platform comprising a plurality of characteristics sensors, and step (e) comprises recording data generated from the plurality of characteristics sensors simultaneously.

30. The method of claim 26, wherein the path maintains the characteristics sensor at a fixed angle relative to the object during at least a portion of step (d).

31. The method of claim 30, wherein the path is based on a plurality angles defined by a user.

32. The method of claim 26, wherein the path maintains the characteristics sensor at a fixed range relative to the object during at least a portion of step (d).

33. The method of claim 32, wherein the fixed range is defined by a user.

34. The method of claim 26, wherein the mobile platform comprises a GPS module constructed to locate the position of the cart, where step (a) is based upon a GPS location of the cart.

35. The method of claim 26, further comprising:
f. processing the characteristics sensor data to generate a file representing the characteristic signature of the object.

36. The method of claim 35, wherein the file comprises a radial graph.
